(19) United States
(12) Patent Application Publication
(10) Pub. No.: US 2025/0197686 A1
(43) Pub. Date: Jun. 19, 2025

(54) ADHESIVE COMPOSITION

(71) Applicant: SHIN-ETSU POLYMER CO., LTD., Chiyoda-ku, Tokyo (JP)

(72) Inventors: Shiori MOMMA, Saitama (JP); Kazuyoshi YOSHIDA, Saitama (JP); Wataru KATAGIRI, Saitama (JP)

(21) Appl. No.: 18/851,685

(22) PCT Filed: Nov. 2, 2022
(86) PCT No.: PCT/JP2022/041043

§ 371 Date: Sep. 27, 2024

(30) Foreign Application Priority Data
Mar. 30, 2022 (JP) 2022-055970

(51) Int. Cl. C09J 7/35

(52) U.S. Cl. CPC C09J 7/35; C09J 2203/326

(57) ABSTRACT

Provided are a resin composition for forming a low dielectric adhesive layer that has good 5G-compatible electrical properties (low dielectric properties), ensures high adhesiveness, suppresses the generation of bubbles, and has a small coefficient of linear thermal expansion (CTE); and an adhesive composition containing the resin composition. The adhesive composition contains a resin composition containing a maleimide resin having a molecular weight of 1000 or more and a benzoxazine resin, and the benzoxazine resin has a site represented by formula (1).

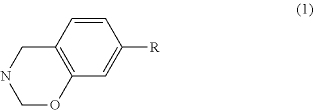

In formula (1), R represents a hydrocarbon group having 4 or more carbon atoms. The hydrocarbon group optionally has an unsaturated binding site.

### TECHNICAL FIELD

The present invention relates to an adhesive composition. More specifically, the present invention relates to an adhesive composition that can be used for adhesive applications of electronic parts and the like.

### BACKGROUND ART

As electronic devices become more compact and lightweight, bonding applications of electronic parts and the like are diversifying, and the demand for laminated bodies provided with an adhesive layer is increasing.

Further, for flexible printed circuit boards (hereinafter, also referred to as FPCs), which are one type of electronic part, there is a need to process large amounts of data at high speed, and so support for high frequencies is progressing. To increase the frequency of FPCs, it is necessary to reduce the dielectric of the components, and low-dielectric base films and low-dielectric adhesives are being developed. In particular, in order to efficiently transmit signals having frequencies in bands of 6 GHz and 28 GHz used in the fifth generation mobile communication system (hereinafter also referred to as 5G), the significance of a base film and an adhesive with low loss even in a millimeter wave band of 28 GHz increases more and more.

However, base resin molecules of low-dielectric adhesives have low polarity, so it is difficult to exhibit adhesiveness with the base film and other components related to electronic parts. Moreover, low-dielectric base films also similarly have poor adhesiveness with adhesives, and so there is a need for improvement in adhesiveness.

For the purpose of achieving good heat resistance and adhesion properties, proposed is a thermosetting resin composition containing a bismaleimide compound (a compound having a maleimide group), a benzoxazine compound, and a triazine compound (see, for example, Patent Literature 1).

### CITATION LIST

### Patent Literature

Patent Literature 1: Japanese Patent Application Laid-Open No. 2014-227542

### SUMMARY OF INVENTION

### Technical Problem

The resin composition described in Patent Literature 1 can afford a cured product with low dielectric and excellent heat resistance due to curing of a low molecular weight maleimide compound with a benzoxazine compound; however, it is not sufficient from the viewpoint of ensuring high adhesiveness, and accordingly there is still room for improvement.

In order to improve the adhesiveness, the present inventors have prepared a resin composition using a high molecular weight maleimide resin and found that the use of a high molecular weight maleimide resin improves the adhesiveness but causes a problem of bubbles in the adhesive layer formed using this resin composition.

Further, when the coefficient of linear thermal expansion (CTE) is large, warpage occurs in a laminate body, resulting in poor processability and poor dimensional stability and adhesiveness of the film. Therefore, a resin composition capable of forming an adhesive layer with a small value of CTE is desired.

Accordingly, it is an object of the present invention to provide a resin composition for forming a low dielectric adhesive layer that has good 5G-compatible electrical properties (low dielectric properties), ensures high adhesiveness, suppresses the occurrence of abnormalities such as bubbles, and has a small coefficient of linear thermal expansion (CTE); and an adhesive composition containing the resin composition.

### Solution to Problem

As a result of diligent research to solve the above-mentioned problems, the present inventors have discovered that a resin composition containing a high molecular weight maleimide resin and a specific benzoxazine resin could solve the above-mentioned problems, thereby completing the present invention.

The present invention includes the following aspects.

[1] An adhesive composition comprising a resin composition containing a maleimide resin having a molecular weight of 1,000 or more and a benzoxazine resin,
wherein the benzoxazine resin has a site represented by formula (1).

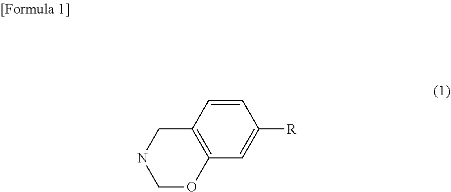

wherein R represents a hydrocarbon group having 4 or more carbon atoms, the hydrocarbon group can have an unsaturated binding site.
[2] The adhesive composition according to [1], wherein R in formula (1) has 20 or less carbon atoms.
[3] The adhesive composition according to [1] or [2], wherein R in formula (1) has a linear structure.
[4] The adhesive composition according to any one of [1] to [3], wherein the hydrocarbon group of R in formula (1) has at least one or more unsaturated binding sites.
[5] The adhesive composition according to [1], wherein R in formula (1) comprises any one of groups represented by formulae (i) to (iv):

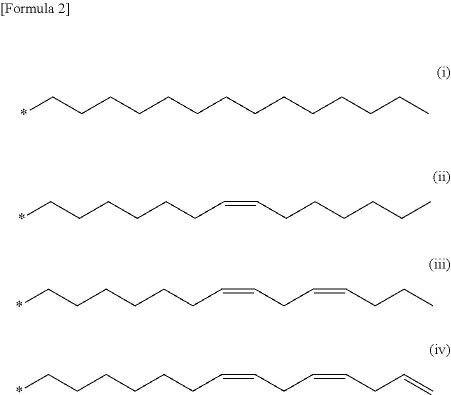 [SMILES: *CCCCCCCCCCCCCC ; *CCCCCC/C=C\CCCCCC ; *CCCCCC/C=C\C/C=C\CCC ; *CCCCCC/C=C\C/C=C\CC=C]

wherein * represents a bond.
[6] The adhesive composition according to any one of [1] to [5], wherein a content of the benzoxazine resin is more than 0 parts by mass and 20 parts by mass or less based on 100 parts by mass of the resin composition.
[7] The adhesive composition according to any one of [1] to [6], wherein the maleimide resin has a softening point of 30° C. or higher.
[8] The adhesive composition according to any one of [1] to [7], wherein the maleimide resin has a softening point of 130° C. or lower.
[9] The adhesive composition according to any one of [1] to [8], wherein when the resin composition further contains an epoxy resin, a content of the epoxy resin is 25 parts by mass or less based on 100 parts by mass of the resin composition.
[10] The adhesive composition according to any one of [1] to [8], wherein the resin composition is free of an epoxy resin.
[11] The adhesive composition according to any one of [1] to [10], further comprising a filler in addition to the resin composition.
[12] An adhesive layer obtained by curing the adhesive composition according to [11].
[13] The adhesive layer according to [12], wherein the adhesive layer has a relative permittivity of 3.5 or less and a dielectric loss tangent of 0.005 or less when measured at a frequency of 28 GHz.
[14] A laminate comprising:
a base film; and
the adhesive layer according to [12] or [13].
   [15] The laminate according to [14], wherein the base film contains a polyether ether ketone (PEEK) resin.
   [16] A coverlay film provided with an adhesive layer, comprising the laminate according to [14] or [15].
   [17] A copper-clad laminate comprising the laminate according to [14] or [15].
   [18] A printed circuit board comprising the laminate according to [14] or [15].
   [19] A shield film comprising the laminate according to [14] or [15].
   [20] A printed circuit board provided with a shield film, comprising the laminate according to [14] or [15].

### Advantageous Effects of Invention

According to the present invention, provided are a resin composition for forming a low dielectric adhesive layer that has good 5G-compatible electrical properties (low dielectric properties), ensures high adhesiveness, suppresses the generation of bubbles, and has a small coefficient of linear thermal expansion (CTE); and an adhesive composition containing the resin composition.

### DESCRIPTION OF EMBODIMENTS

Hereinafter, the adhesive composition of the present invention, the laminate including an adhesive layer composed of the adhesive composition, and electronic-parts-related components including the laminate will be described in detail, but the following description of the constituent requirements is one example of an embodiment of the present invention, and the present invention is not limited to the subject matters described here.

### (Adhesive Composition)

The adhesive composition of the present invention contains a resin composition.

The resin composition contains a maleimide resin having a molecular weight of 1,000 or more and a benzoxazine resin having a site represented by the following formula (1).

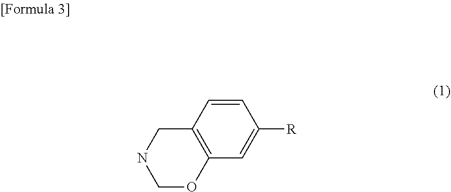

In formula (1), R represents a hydrocarbon group having 4 or more carbon atoms. The hydrocarbon group can have an unsaturated binding site.

The resin composition can, optionally, contain other resin components in addition to the resin component of the maleimide resin having a molecular weight of 1,000 or more and the benzoxazine resin having a site represented by the formula (1).

The adhesive composition of the present invention may contain other components such as a filler, a curing accelerator, and various additives, in addition to the resin composition contained as a resin component.

Further, in the present specification, the “resin composition” is composed of a resin component without other components such as a filler (especially an inorganic filler, etc.), a curing accelerator, and various additives.

The adhesive composition can contain a high molecular weight maleimide resin and a benzoxazine resin having a specific site to form a low dielectric adhesive layer that exhibits good electrical properties (low dielectric properties), high adhesiveness, suppression of bubbles, and low CTE.

### <Maleimide Resin>

The resin composition according to the present invention contains a maleimide resin having a molecular weight of 1,000 or more.

The maleimide resin is a resin having a maleimide group. More preferably, in the present invention, the maleimide resin is particularly a bismaleimide resin having two maleimide groups.

The maleimide resin has good metal adhesiveness with an unsaturated bond and is crosslinkable, and the adhesive composition of the present invention containing the maleimide resin has a high crosslink density and excellent heat resistance, solvent resistance, and the like.

Since the maleimide resin contains an imide skeleton, high metal adhesiveness is imparted to the adhesive composition, and an acid or a base is less likely to enter between a cured product of the adhesive composition and a metal, whereby chemical resistance can be improved.

The maleimide resin reacts with the benzoxazine resin to form a crosslinked structure. The maleimide resin reacts with the benzoxazine resin to increase the crosslink density of the adhesive composition, so that high adhesion properties to adherends, heat resistance of an adhesive cured product, a low coefficient of linear thermal expansion (CTE) and can be exhibited.

Examples of the maleimide resin include modified maleimide obtained by modifying a maleimide resin with a compound having a primary amine; and a polymer obtained by chain extension of an amine-modified product such as a dimer acid or a trimer acid with maleic anhydride, pyromellitic acid, or the like.

As the maleimide resin, a commercially available compound can also be used, and specifically, a bismaleimide resins with the trade name “SKL-3000-T50” or “SLK-2600-A50” manufactured by Shin-Etsu Chemical Co., Ltd, for example, can be suitably used.

In the present invention, the maleimide resin is preferably used as the base resin of the resin composition.

Therefore, the content of the maleimide resin is preferably more than 50 parts by mass based on 100 parts by mass of the resin composition, from the viewpoint of reducing the dielectric and enhancing the adhesiveness. More specifically, the lower limit of the content of the maleimide resin in the resin composition is more preferably 80 parts by mass or more from the viewpoint of enabling further reduction of the dielectric, and further preferably 90 parts by mass or more from the viewpoint of further enhancing the adhesiveness. On the other hand, the upper limit of the content of the maleimide resin in the resin composition is more preferably 99.8 parts by mass or less, and further preferably 99 parts by mass or less.

The maleimide resin may be used by mixing a plurality of different types of maleimide resins. When a plurality of types of maleimide resins are mixed and used, the content is the total amount obtained by adding the plurality of types of maleimide resins.

The melting point or softening point of the maleimide resin is preferably 30° C. or higher and 130° C. or lower, from the viewpoints of imparting fluidity to the adhesive composition at the temperature of thermal lamination or thermal pressing, allowing the adhesive composition to sufficiently follow the surface of the base film or metal substrate and exhibiting excellent adhesiveness and chemical resistance during curing.

The maleimide resin used in the present invention has a weight average molecular weight of 1,000 or more, preferably 3,000 or more, and more preferably 5,000 or more. When the weight average molecular weight is 3,000 or more, appropriate flexibility can be imparted to the cured product of the adhesive composition. When the weight average molecular weight is 5,000 or more, excellent adhesion properties can be exhibited. The weight-average molecular weight of the maleimide resin is preferably 40,000 or less more preferably 20,000 or less, and further preferably 15,000 or less. When the weight average molecular weight is 40,000 or more, an imide skeleton capable of exhibiting sufficient metal adhesiveness can be contained. When the weight average molecular weight is 15,000 or less, compatibility with the benzoxazine resin is improved.

### <Benzoxazine Resin>

The benzoxazine resin reacts with the maleimide resin to increase the crosslink density of the adhesive composition, so that high adhesion properties to adherends can be exhibited. The benzoxazine resin can react with the maleimide resin to form a crosslinked structure and exhibit a low coefficient of linear thermal expansion (CTE).

The benzoxazine resin according to the present invention has a site represented by the following formula (1).

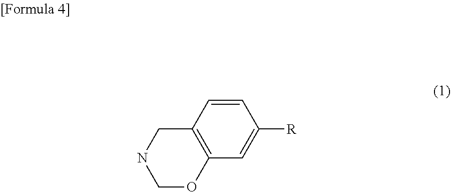

In formula (1), R represents a hydrocarbon group having 4 or more carbon atoms. In the reaction between a benzoxazine resin and a maleimide resin, a low molecular weight decomposition product is generated due to overreaction, which causes bubbles. When R of the benzoxazine resin is a hydrocarbon group having 4 or more carbon atoms, the volatility of the decomposition product during the curing reaction can be lowered, thereby suppressing the generation of bubbles. In addition, the compatibility with a high molecular weight maleimide resin can be improved, and the curing temperature can be lowered.

The hydrocarbon group can have an unsaturated binding site. Although the detailed reaction mechanism is unclear when the hydrocarbon group has an unsaturated bond site, the reaction temperature with the maleimide resin is lowered, and a low coefficient of linear thermal expansion can be expressed even in low temperature curing. In addition, the effect of reducing the coefficient of linear thermal expansion can also be expressed by increasing the crosslink density.

The adhesive composition of the present invention contains a resin composition containing a high molecular weight maleimide resin and a specific benzoxazine resin having a site represented by formula (1), whereby the adhesive composition of the present invention exhibits good low dielectric and forms a good membrane (adhesive layer) by low-temperature curing, and the formed adhesive layer exhibits excellent adhesiveness, bubble suppression, and a low CTE, as shown in the results of the following Examples.

In formula (1), the number of carbon atoms of R is more preferably 12 or more from the viewpoint of further improving the compatibility, further more preferably 14 or more and particularly preferably 15 or more from the viewpoint of reducing the steric hindrance at the unsaturated binding site during the reaction. Further, the number of carbon atoms of R is preferably 20 or less from the viewpoint of facilitating the procurement of the benzoxazine resin.

In formula (1), R preferably has a linear structure, whereby excellent flexibility of the adhesive layer can be secured.

In formula (1), R is preferably any one of groups represented by the following formulae (i) to (iv), for example.

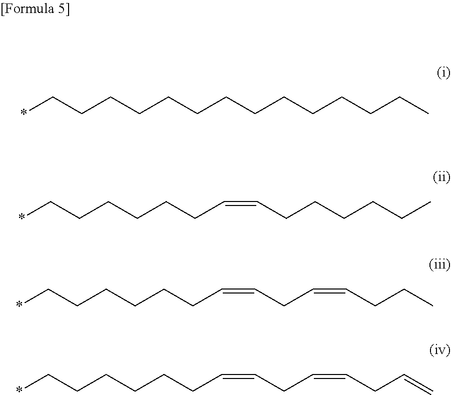 [SMILES: *CCCCCCCCCCCCCC ; *CCCCCC/C=C\CCCCCC ; *CCCCCC/C=C\C/C=C\CCC ; *CCCCCC/C=C\C/C=C\CC=C]

In formulae (i) to (iv), * represents a bond.

Further, the benzoxazine resin according to the present invention is not limited to a benzoxazine resin in which R is represented by one type, but may be a benzoxazine resin in which a plurality of types, that is, at least two or more types of benzoxazine resins in which the types of R in formula (1) are different are mixed.

For example, when a benzoxazine resin having a site of R represented by the above formulae (i) to (iv) is contained, R is not limited to a benzoxazine resin represented by any one of the above formulae (i) to (iv), and R may be a benzoxazine resin in which a plurality of different benzoxazine resins selected from the above formulae (i) to (iv) are mixed.

More specifically, for example, at least two of benzoxazine resins selected from the group consisting of the following may be contained:
a benzoxazine resin having a site represented by formula (1), wherein R in formula (1) is a group represented by formula (i);
a benzoxazine resin having a site represented by formula (1), wherein R in formula (1) is a group represented by formula (ii);
a benzoxazine resin having a site represented by formula (1), wherein R in formula (1) is a group represented by formula (iii); and
a benzoxazine resin having a site represented by formula (1), wherein R in formula (1) is a group represented by formula (iv).

The benzoxazine resin preferably has a structure containing two or more oxazine skeletons in the molecule, whereby the crosslink density can be improved while increasing the content of the maleimide resin with high adhesiveness.

Examples of the benzoxazine resin include a benzoxazine resin represented by the following formula (2).

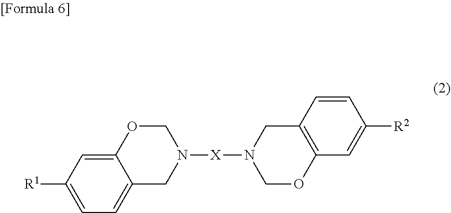

In formula (2), R¹ and R² are each defined the same as R in formula (1). X represents a divalent organic group. For example, X represents an alkylene group having 1 to 5 carbon atoms or a group represented by the following formula (3).

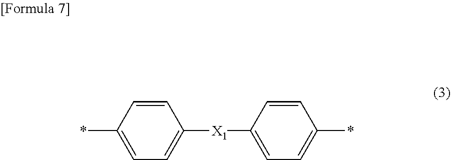

In formula (3), X1 represents an alkylene group having 1 to 5 carbon atoms. * represents a bond.

In formula (2), R¹ and R² each more preferably represent any one of the alkyl groups represented by formulae (i) to (iv).

The content of the benzoxazine resin is more than 0 parts by mass based on 100 parts by mass of the resin composition, preferably 1 part by mass or more, and more preferably 5 parts by mass or more from the viewpoint of enhancing the reactivity. Further, the content of the benzoxazine resin is preferably 20 parts by mass or less from the viewpoint of achieving the low dielectric, and more preferably 10 parts by mass or less from the viewpoint of increasing the relative amount of the maleimide resin blended and enhancing the adhesiveness.

When the content of the benzoxazine resin is within the above range, low dielectric properties and adhesiveness of an adhesive layer formed using an adhesive composition containing the resin composition can be satisfactorily ensured.

The benzoxazine resin may be used by mixing a plurality of different types of benzoxazine resins. When a plurality of types of benzoxazine resins are mixed and used, the content is the total amount obtained by adding the plurality of types of benzoxazine resins.

The melting point or softening point of the benzoxazine resin is preferably lower than 120° C. from the viewpoints of imparting fluidity to the adhesive composition at the temperature of thermal lamination or thermal pressing, suppressing whitening, allowing the adhesive composition to sufficiently follow the surface of the base film or metal substrate, and exhibiting excellent adhesiveness.

The melting point or softening point of the benzoxazine resin is preferably 40° C. or higher from the viewpoints of increasing the elastic modulus of the adhesive composition at room temperature, improving the adhesive force, and suppressing whitening.

The mixing ratio of the maleimide resin to the benzoxazine resin is, for example, preferably maleimide resin:benzoxazine resin=50:50 to 99:1 in terms of mass ratio from the viewpoint of reducing the dielectric and enhancing the adhesiveness, more preferably 80:20 to 99:1 from the viewpoint of achieving the low dielectric, and further preferably 90:10 to 95:5 from the viewpoint of further enhancing the adhesiveness.

The resin composition according to the present invention may contain other resin components in addition to the maleimide resin and the benzoxazine resin as long as the effects of the present invention are not impaired.

### <Other Resin Components>

The resin composition according to the present invention may contain a thermosetting resin other than the maleimide resin and the benzoxazine resin. Alternatively, the resin composition of the present invention may contain a styrene-based elastomer or other thermoplastic resin.

Examples of other thermoplastic resin include epoxy resins, phenol resins, unsaturated imide resins (excluding the above-mentioned maleimide resins), cyanate resins, isocyanate resins, oxetane resins, amino resins, unsaturated polyester resins, allyl resins, dicyclopentadiene resins, silicone resins, triazine resins, and melamine resins. Among these, from the viewpoint of formability and electrical insulation, epoxy resins are excellent, but from the viewpoint of dielectric properties, it is preferable to contain almost no epoxy resin, because the adhesiveness can be exhibited by blending of maleimide resin and oxazine resin. Therefore, when the resin composition contains an epoxy resin, the content of the epoxy resin is preferably less than 25 parts by mass based on 100 parts by mass of the resin composition from the viewpoint of reducing the dielectric, and no epoxy resin is more preferably contained from the viewpoint of suppressing whitening and reducing the dielectric.

The styrene-based elastomer is a copolymer mainly composed of blocks and random structures of an unsaturated hydrocarbon and an aromatic vinyl compound, or hydrogenated products thereof.

Examples of the aromatic vinyl compound include styrene, t-butylstyrene, α-methylstyrene, divinylbenzene, 1,1-diphenylethylene, N,N-diethyl-p-aminoethylstyrene and vinyltoluene.

Examples of the unsaturated hydrocarbon include ethylene, propylene, butadiene, isoprene, isobutene, 1,3-pentadiene, and 2,3-dimethyl-1,3-butadiene.

Examples of the other thermoplastic resin include phenoxy resins, polyamide resins, polyester resins, polycarbonate resins, polyphenylene oxide resins, polyurethane resins, polyacetal resins, polyethylene resins, polypropylene resins, polybutadiene resins and polyvinyl resins. These thermoplastic resins can be used singly or in combinations of two or more.

### <Other Components>

The adhesive composition of the present invention can contain other components such as a filler, a curing accelerator, and various additives in addition to the resin composition containing a maleimide resin, a benzoxazine resin, and the above-mentioned other resin components.

Examples of the other components include a filler, a curing accelerator, a flame retardant, a heat aging inhibitor, a leveling agent, a defoaming agent, and a pigment, which can be contained to the extent that does not affect the function of the adhesive composition.

### <<Filler>>

The adhesive composition of the present invention preferably contains a filler.

The filler according to the present invention is preferably an inorganic filler, for example, from the viewpoint of heat resistance and control of mechanical properties of the adhesive composition.

Examples of the inorganic filler include silica, alumina, titanium oxide, mica, beryllia, barium titanate, potassium titanate, strontium titanate, calcium titanate, aluminum carbonate, magnesium hydroxide, aluminum hydroxide, aluminum silicate, calcium carbonate, calcium silicate, magnesium silicate, silicon nitride, boron nitride, clay, talc, aluminum borate, silicon carbide, quartz powder, short glass fiber, fine glass powder, and hollow glass. Among these, silica, mica, talc, quartz powder, short glass fiber, fine glass powder, and hollow glass are preferable from the viewpoint of, for example, dielectric properties, heat resistance, and low thermal expansivity, and silica is more preferable from the viewpoint of enabling film thinning.

Examples of the silica include precipitated silica having a high moisture content produced by a wet process, and dry process silica containing almost no bound moisture produced by a dry process.

The inorganic filler (inorganic filler) may be subjected to a surface treatment with a coupling agent.

The filler according to the present invention may contain, for example, an organic filler from the viewpoint of dispersibility and brittleness.

From the viewpoint of electrical properties, the organic filler is preferably a styrene-based true spherical filler, and more preferably a styrene-based hollow filler.

These can be used singly or in combinations of two or more.

The content of the filler contained in the adhesive composition of the present invention is preferably 50 to 1,000 parts by mass based on 100 parts by mass of the resin composition from the viewpoint of being able to express a coefficient of low linear expansion, and is more preferably 80 to 500 parts by mass based on 100 parts by mass of the resin composition from the viewpoint of being able to express low dielectric properties and adhesiveness. From the viewpoint of enhancing the adhesiveness, the content is further preferably 150 to 350 parts by mass based on 100 parts by mass of the resin composition.

The shape of the filler is not particularly limited, and can be appropriately selected according to the intended purpose. For example, the inorganic filler may be a spherical inorganic filler or a non-spherical inorganic filler, but from the viewpoint of the coefficient of thermal expansion (CTE) and the film strength, a non-spherical inorganic filler is preferable. The shape of the non-spherical inorganic filler may be any three dimensional shape other than a sphere (substantially a perfect sphere), and examples thereof include a plate shape, a scale shape, a columnar shape, a chain shape, and a fibrous shape. Among these, from the viewpoint of the coefficient of thermal expansion (CTE) and the film strength, a plate shape or a scale shape inorganic filler is preferable, and a plate shape inorganic filler is more preferable.

The flame retardant can be either an organic flame retardant or an inorganic flame retardant. Examples of organic flame retardants include: phosphorus-based flame retardants, including melamine phosphate, melamine polyphosphate, guanidine phosphate, guanidine polyphosphate, ammonium phosphate, ammonium polyphosphate, ammonium phosphate amide, ammonium polyphosphate amide, carbamoyl phosphate, carbamoyl polyphosphate, aluminum trisdiethylphosphinate, aluminum trismethylethylphosphinate, aluminum trisdiphenylphosphinate, zinc bisdiethylphosphinate, zinc bismethylethylphosphinate, zinc bisdiphenylphosphinate, titanyl bisdiethylphosphinate, titanium tetrakisdiethylphosphinate, titanyl bismethylethylphosphinate, titanium tetrakismethylethylphosphinate, titanyl bisdiphenylphosphinate and titanium tetrakisdiphenylphosphinate; nitrogen-based flame retardants, including triazine compounds like melamine, melam and melamine cyanurate, cyanuric acid compounds, isocyanuric acid compounds, triazole compounds, tetrazole compounds, diazo compounds and urea; and silicon-based flame retardants, including silicone compounds and silane compounds. Examples of inorganic flame retardants include metal hydroxides, including aluminum hydroxide, magnesium hydroxide, zirconium hydroxide, barium hydroxide and calcium hydroxide; metal oxides, including tin oxide, aluminum oxide, magnesium oxide, zirconium oxide, zinc oxide, molybdenum oxide and nickel oxide; and zinc carbonate, magnesium carbonate, barium carbonate, zinc borate and hydrated glass. These flame retardants can be used in combinations of two or more.

Examples of the heat aging inhibitor include phenol-based antioxidants, including 2,6-di-tert-butyl-4-methylphenol, n-octadecyl-3-(3′,5′-di-tert-butyl-4′-hydroxyphenyl)propionate, tetrakis[methylene-3-(3,5-di-tert-butyl-4-hydroxyphenyl)propionate]methane, pentaerythritol tetrakis[3-(3,5-di-t-butyl-4-hydroxyphenol and triethylene glycol-bis[3-(3-t-butyl-5-methyl-4-hydroxyphenyl)propionate; sulfur-based antioxidants, including dilauryl-3,3′-thiodipropionate and dimyristyl-3,3′-dithiopropionate; and phosphorus-based antioxidants, including trisnonylphenylphosphite and tris(2,4-di-tert-butylphenyl)phosphite. These can be used singly or in combinations of two or more.

### (Adhesive Layer)

The adhesive layer according to the present invention is formed using the above-mentioned adhesive composition of the present invention.

The adhesive composition that forms the adhesive layer can be cured.

The curing method is not particularly limited, and can be appropriately selected according to the intended purpose. Examples of the curing method include heat curing.

The thickness of the adhesive layer is not particularly limited, and can be appropriately selected according to the intended purpose. For example, the thickness is preferably 3 μm or more, and more preferably 5 μm or more. In addition, the thickness is preferably 100 μm or less, more 50 μm or less, and further preferably 30 μm or less. When the thickness of the adhesive layer is 3 μm or more, adhesive force can be sufficiently exhibited, and when the thickness is 5 μm or more, the adhesive layer can follow a level difference of a pattern or the like of a printed circuit board. When the thickness of the adhesive layer is 50 μm or less, the laminate can be made thin, and when the thickness is 30 μm or less, the resin flow can be accurately controlled.

### <Method for Producing Adhesive Layer>

The adhesive layer can be produced by forming the adhesive composition as a film.

The adhesive composition can be produced by mixing the above-mentioned maleimide resin and the above-mentioned benzoxazine resin. The mixing method is not specifically limited so long as a uniform adhesive composition is obtained. Since the adhesive composition is preferably used in the form of a solution or a dispersion, a solvent is generally used.

Examples of the solvent include alcohols, including methanol, ethanol, isopropyl alcohol, n-propyl alcohol, isobutyl alcohol, n-butyl alcohol, benzyl alcohol, ethylene glycol monomethyl ether, propylene glycol monomethyl ether, diethylene glycol monomethyl ether and diacetone alcohol; ketones, including acetone, methyl ethyl ketone, methyl isobutyl ketone, methyl amyl ketone, cyclohexanone and isophorone; aromatic hydrocarbons, including toluene, xylene, ethylbenzene and mesitylene; esters, including methyl acetate, ethyl acetate, butyl acetate, ethylene glycol monomethyl ether acetate and 3-methoxybutyl acetate; and aliphatic hydrocarbons, including hexane, heptane, cyclohexane and methylcyclohexane. These solvents can be used singly or in combinations of two or more. In particular, by adding a small amount of cyclohexanone to toluene, which can dissolve resins with low polarity, the compatibility with the curing agent and the like is improved, and the adhesive layer can be made uniform.

When the adhesive composition is a solution or a dispersion (resin varnish) including a solvent, the application to the base film and the formation of the adhesive layer can be smoothly carried out to readily obtain an adhesive layer having a desired thickness.

When the adhesive composition includes a solvent, the solid concentration is preferably in the range of 3 to 80% by mass, and more preferably 10 to 50% by mass, from the viewpoint of workability including formation of the adhesive layer. If the solid concentration is 80% by mass or less, a solution with a suitable viscosity can be obtained to facilitate uniform coating.

As a more specific embodiment of the method for producing the adhesive layer, a B-stage adhesive layer can be formed by coating a surface of a base film with a resin varnish containing the above-mentioned adhesive composition and a solvent to form a resin varnish layer, and then removing the solvent from the resin varnish layer. As used herein, adhesive layer in B-stage refers to a semi-cured state in which the adhesive composition is uncured or part of the adhesive composition has started to cure, so that the curing of the adhesive composition further proceeds by heating or the like.

Here, the method of applying the resin varnish on the base film is not particularly limited, and can be appropriately selected according to the intended purpose. Examples of the method include a spray method, a spin coating method, a dip method, a roll coating method, a blade coating method, a doctor roll method, a doctor blade method, a curtain coating method, a slit coating method, a screen printing method, an inkjet method and a dispensing method.

The B-stage adhesive layer can be further heated, for example to form a cured adhesive layer.

### <Properties of Adhesive Layer>

The relative permittivity (εr) of the adhesive layer obtained by curing the adhesive composition of the present invention at a frequency of 28 GHz is preferably of 3.5 or less, and more preferably 2.7 or less. The dielectric loss tangent (tan δ) of the adhesive layer at a frequency of 28 GHz is preferably 0.005 or less, more preferably 0.0025 or less, and further preferably 0.0015 or less.

If the relative permittivity is 3.5 or less and the dielectric loss tangent is 0.005 or less, the adhesive layer can also be used even for high-frequency FPC-related products with strict requirements for electrical properties. Further, if the relative permittivity is 2.7 or less and the dielectric loss tangent is 0.0025 or less, the electrical properties expected for components of 5G-compatible high-frequency FPC-related products can be satisfied, resulting in LCP-equivalent electrical properties, and the adhesive layer can be suitably used even for high-frequency FPC-related products with strict requirements for electrical properties. In addition, if the dielectric loss tangent is 0.0015 or less, the adhesive layer can be suitably used even for high-frequency FPC-related products utilizing millimeter waves.

### [Relative Permittivity and Dielectric Loss Tangent]

The relative permittivity and dielectric loss tangent of the adhesive layer can be measured using a network analyzer MS46122B (manufactured by Anritsu Corporation) and an open resonator Fabry-Perot DPS-03 (manufactured by KEYCOM Corporation) by an open resonator method under the conditions of a temperature of 23° C. and a frequency of 28 GHz.

The upper limit of the coefficient of linear thermal expansion (CTE) (CTE at 20° C. to 140° C.) of the adhesive layer obtained by curing the adhesive composition of the present invention is preferably less than 500 ppm/K from the viewpoint of suppressing warpage of the laminate, and more preferably less than 20 ppm/K from the viewpoint of ensuring dimensional stability and adhesiveness of the film. The upper limit of the coefficient of linear thermal expansion is further preferably less than 100 ppm/K from the viewpoint of being able to be used suitably with LCP and MPI, which are commonly used low dielectric base films. The lower limit of the coefficient of linear thermal expansion (CTE) (CTE at 20° C. to 140° C.) of the adhesive layer is preferably 10 ppm/K or more, and more preferably 20 ppm/K or more.

The coefficient of linear thermal expansion (CTE) can be determined by a thermomechanical analysis (TMA) apparatus in accordance with JIS K 7197:1991. For example, the coefficient of linear thermal expansion (ppm/K) can be measured via a tensile mode using a thermomechanical analyzer (product name: SII/SS7100 manufactured by Hitachi High-Tech Science Corporation) under the conditions of a load of 50 mN and a temperature increase rate of 5° C./min in the range of 10° C. to 200° C., and can be determined from the slope in the range of 20° C. to 140° C.

### (Laminate)

The laminate of the present invention includes a base film and the above-mentioned adhesive layer on at least one surface of the base film.

### <Base Film>

The base film used in the present invention can be selected according to the laminate application. For example, when the laminate is to be used as a coverlay film or a copper-clad laminate (CCL), examples of the base film include a polyimide film, a polyether ether ketone film, a polyphenylene sulfide film, an aramid film, a polyethylene naphthalate film, a liquid crystal polymer film, a polyphenylene ether film, and a syndiotactic polystyrene film. Among these, a polyimide film, a polyether ether ketone (PEEK) film, a polyethylene naphthalate film and a liquid crystal polymer film are preferable from the viewpoint of adhesion properties and electrical properties.

The base film can contain a filler. The type of the filler is not particularly limited, and can be appropriately selected according to the intended purpose. For example, the above-mentioned filler can be used.

Further, when the laminate of the present invention is to be used as a bonding sheet, the base film needs to be a release film, and examples thereof include a polyethylene terephthalate film, a polyethylene film, a polypropylene film, silicone-treated release paper, polyolefin resin-coated paper, a TPX (polymethylpentene) film and a fluororesin film.

When the laminate of the present invention is to be used as a shield film, the base film needs to be a film having an electromagnetic wave shielding ability, and examples thereof include a laminate of a protective insulating layer and a metal foil.

### (Coverlay Film)

An example of a preferable embodiment of the laminate according to the present invention is a coverlay film.

For example, when producing an FPC, a laminate having an adhesive layer called a “coverlay film” is usually used to protect the wiring portion. This coverlay film includes an insulating resin layer and an adhesive layer formed on the surface thereof.

The coverlay film is a laminate in which the above-mentioned adhesive layer is formed on at least one surface of the above-mentioned base film, and it is generally difficult to separate the base film and the adhesive layer.

The thickness of the base film included in the coverlay film is preferably 5 to 100 μm, more preferably 5 to 50 μm, and further preferably 5 to 30 μm. When the thickness of the base film is equal to or less than this upper limit, a thinner coverlay film can be made. If the thickness of the base film is equal to or more than this lower limit, the printed circuit board can be designed easily and handling is also good.

The coverlay film can be produced by, for example, coating a surface of the above-mentioned base film with a resin varnish containing the above-mentioned adhesive composition and a solvent to form a resin varnish layer, and then removing the solvent from the resin varnish layer to produce a coverlay film in which a B-stage adhesive layer is formed.

The drying temperature when removing the solvent is preferably 40 to 250° C., and more preferably 70 to 170° C.

The drying is carried out by passing the laminate having the adhesive composition applied thereon through a furnace in which hot air drying, far infrared heating, high-frequency induction heating or the like is carried out.

Further, optionally, a release film can be laminated onto the surface of the adhesive layer for storage and the like. Examples of the usable release film include those known in the art, including a polyethylene terephthalate film, a polyethylene film, a polypropylene film, silicone-treated release paper, polyolefin resin-coated paper, a TPX film and a fluororesin film.

Since the coverlay film according to the present invention uses the low-dielectric adhesive composition of the present invention, high-speed transmission by electronic devices is possible, and adhesive stability with electronic devices is also excellent.

### (Bonding Sheet)

An example of a preferable embodiment of the laminate according to the present invention is a bonding sheet.

The bonding sheet includes the above-mentioned adhesive layer formed on the surface of a release film (base film). In another embodiment of the bonding sheet, the adhesive layer can be incorporated between two release films. The release film is peeled off when the bonding sheet is used. The same release films as those described above in the section (Coverlay film) can be used.

The thickness of the base film included in the bonding sheet is preferably 5 to 100 μm, more preferably 25 to 75 μm, and further preferably 38 to 50 pn. When the thickness of the base film is within this range, the bonding sheet can be easily produced and handling is also good.

Examples of the method for producing the bonding sheet include a method in which the surface of a release film is coated with a resin varnish containing the above-mentioned adhesive composition and a solvent, and drying is performed in the same manner as in the case of the coverlay film.

Since the bonding sheet according to the present invention uses the low-dielectric adhesive composition of the present invention, high-speed transmission by electronic devices is possible, and adhesive stability with electronic devices is also excellent.

### (Copper-Clad Laminate (CCL))

An example of a preferable embodiment of the laminate according to the present invention is a copper-clad laminate in which a copper foil is bonded to an adhesive layer in the laminate of the present invention.

The copper-clad laminate, which is formed by bonding a copper foil onto the above-mentioned laminate, is composed of, for example, a base film, an adhesive layer and a copper foil, in that order. The adhesive layer and the copper foil can be formed on both sides of the base film.

The adhesive composition used in the present invention also has excellent adhesion properties with articles including copper.

Since the copper-clad laminate according to the present invention uses the low-dielectric adhesive composition of the present invention, high-speed transmission by electronic devices is possible and the adhesive stability is excellent.

Examples of the method for producing the copper-clad laminate include a method in which the adhesive layer of the above-mentioned laminate and a copper foil are brought into surface contact, heat laminating is performed at 80° C. to 200° C., and then the adhesive layer is cured by after-curing. The after-curing conditions can be, for example, 100° C. to 200° C. for 30 minutes to 4 hours in an inert gas atmosphere. The copper foil is not particularly limited, and an electrolytic copper foil, a rolled copper foil and the like can be used.

### (Printed Circuit Board)

An example of a preferable embodiment of the laminate according to the present invention is a printed circuit board in which copper wiring is bonded to an adhesive layer in the laminate of the present invention.

The printed circuit board is obtained by forming an electronic circuit on the above-mentioned copper-clad laminate.

The printed circuit board, which is formed by using the above-mentioned laminate and bonding a base film and copper wiring, is composed of a base film, an adhesive layer and copper wiring, in that order. The adhesive layer and the copper wiring can be formed on both sides of the base film.

The printed circuit board is produced by, for example, sticking a coverlay film onto the surface having the wiring portion with the adhesive layer arranged between the coverlay film and the surface by heat pressing or the like.

Since the printed circuit board according to the present invention uses the low-dielectric adhesive composition of the present invention, high-speed transmission by electronic devices is possible and the adhesive stability is excellent.

Examples of the method for producing the printed circuit board according to the present invention include a method in which the adhesive layer of the above-mentioned laminate and copper wiring are brought into contact, heat laminating is performed at 80° C. to 200° C., and then the adhesive layer is cured by after-curing. The after-curing conditions can be, for example, 100° C. to 200° C. for 30 minutes to 4 hours. The shape of the copper wiring is not particularly limited, and an appropriate shape and the like can be selected as desired.

### (Shield Film)

An example of a preferable embodiment of the laminate according to the present invention a shield film.

The shield film is a film for shielding various electronic devices in order to cut electromagnetic noise that can affect and cause various electronic devices, including computers, mobile phones, analytical devices and the like, to malfunction. Another name for a shield film is electromagnetic wave shield film.

The electromagnetic wave shield film is formed by, for example, laminating an insulating resin layer, a metal layer, and the adhesive layer according to the present invention, in that order.

Since the shield film according to the present invention uses the low-dielectric adhesive composition of the present invention, high-speed transmission by electronic devices is possible, and adhesive stability with electronic devices is also excellent.

(Printed Circuit Board Provided with a Shield Film)

An example of a preferable embodiment of the laminate according to the present invention is a printed circuit board provided with a shield film.

A printed circuit board provided with a shield film is formed by sticking the above-mentioned electromagnetic wave shield film on a printed circuit board having a printed circuit provided on at least one side of the substrate.

The printed circuit board provided with a shield film has, for example, a printed circuit board, an insulating film adjacent to the surface of the printed circuit board on the side where the printed circuit is provided, and the above-mentioned electromagnetic wave shield film.

Since the printed circuit board provided with a shield film according to the present invention uses the low-dielectric adhesive composition of the present invention, high-speed transmission by electronic devices is possible and the adhesive stability is excellent.

### EXAMPLES

The present invention will now be described in more detail with reference to the following Examples, but the scope of the present invention is not limited to these Examples. In the following, unless otherwise specified, parts and % are based on mass.

### (Bismaleimide Resin)

A bismaleimide resin with the trade name “SLK-3000-T50” manufactured by Shin-Etsu Chemical Co., Ltd. was used. The softening point is 40° C., and the weight average molecular weight is 12,545.

### (Bismaleimide Resin)

A bismaleimide resin with the trade name “SKL-6895-M90” manufactured by Shin-Etsu Chemical Co., Ltd. was used. The softening point is 60° C., and the weight average molecular weight is 980.

### (Benzoxazine Resin)

A benzoxazine resin with the trade name “CR-276” manufactured by Tohoku Chemical Industries, Ltd. was used. The “CR-276” is a benzoxazine resin represented by any one of formulae (i) to (iv), which has a structure of formula (1-1) in which R¹ and R² may be different from each other.

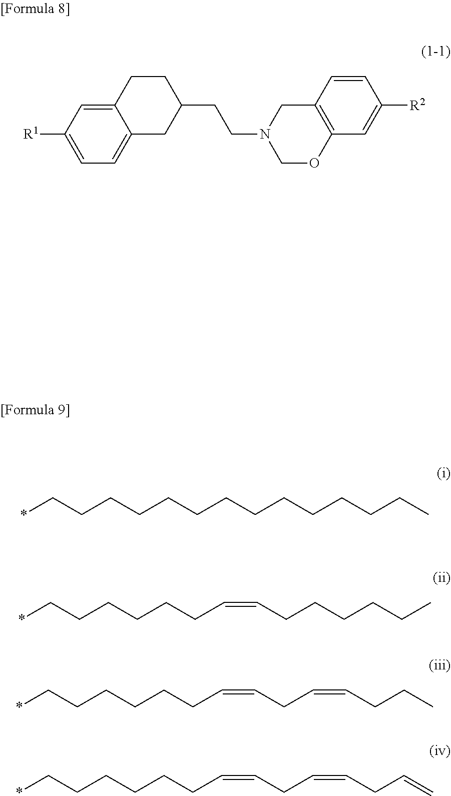

In formulae (i) to (iv), * represents a bond.
The benzoxazine resin of “CR-276” is liquid at room temperature.

### (Benzoxazine Resin)

A benzoxazine resin with the trade name “BZ-LB-MDA” manufactured by Tohoku Chemical Industries, Ltd. was used. The “BZ-LB-MDA” is a benzoxazine resin represented by any one of formulae (i) to (iv), which has a structure of formula (1-2) in which R¹ and R² may be different from each other.

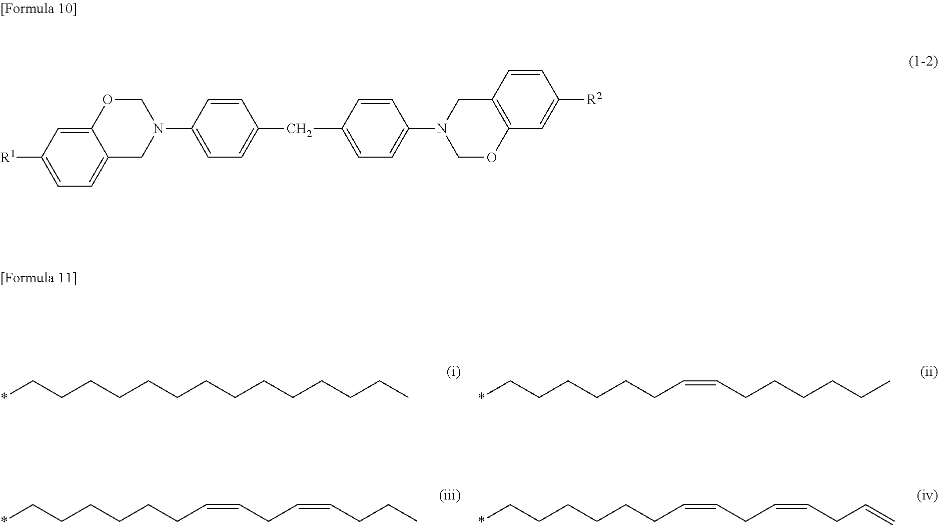

In formulae (i) to (iv), * represents a bond.

### (Benzoxazine Resin)

A benzoxazine resin with the trade name “ALP-d” (liquid) manufactured by Shikoku Chemicals Corporation was used.

### (Inorganic Filler (Silica))

An inorganic filler with the trade name “SO-C2” manufactured by Admatechs Company Limited, which has a particle size of 0.4 to 0.6 μm and a specific surface area of 4 to 7 m²/g, was used.

### (Solvent)

A mixed solvent composed of toluene and cyclohexanone (mass ratio=97:3) was used.

### (Base Film)

As the base film, “Shin-Etsu Sepla Film PEEK” (polyether ether ketone, thickness of 50 μm) manufactured by Shin-Etsu Polymer Co., Ltd. was used. The storage modulus of the base film at 200° C. was 5×10⁸.

### (Electrolytic Copper Foil)

As the electrolytic copper foil, “TQ-M7-VSP” (electrolytic copper foil, thickness of 12 μm, glossy surface Rz of 1.27 μm, glossy surface Ra of 0.197 μm, glossy surface Rsm of 12.95 μm) manufactured by Mitsui Mining & Smelting Co., Ltd. was used.

### (Release Film)

As the release film, NP75SA (silicone release PET film, 75 μm) manufactured by Panac Co., Ltd. was used.

### Example 1

A resin varnish containing an adhesive composition having a solid content concentration of 50% by mass was prepared by adding each of the components shown in Table 1 constituting the adhesive layer in the ratio shown in Table 1, and dissolving the components in a solvent.

Each of the components constituting the resin composition in the adhesive composition are as shown in Table 1.

The relative permittivity and dielectric loss tangent at a frequency of 28 GHz of the adhesive layer obtained by curing using the resin varnish of Example 1 were also measured.

### [Relative Permittivity and Dielectric Loss Tangent]

The relative permittivity and dielectric loss tangent of the adhesive layer were measured using a network analyzer MS46122B (manufactured by Anritsu Corporation) and an open resonator Fabry-Perot DPS-03 (manufactured by KEYCOM Corporation) by an open resonator method under the conditions of a temperature of 23° C. and a frequency of 28 GHz. The measurement sample was formed by applying a resin varnish on the release film with a roll, then placing the film provided with a coating film in an oven, and drying at 110° C. for 4 minutes to form a B-stage adhesive layer (thickness of 50 μm). Next, the adhesive layer was heat-laminated at 150° C. such that its adhesive surfaces were in contact with each other to form a pre-curing adhesive film (thickness of 100 μm). This pre-curing adhesive film (thickness of 100 μm) was placed in an oven and heat-cured at 180° C. for 60 minutes to prepare a cured adhesive film (100 mm×100 mm). The release film was peeled from the cured adhesive film, and the relative permittivity and dielectric loss tangent of the adhesive layer were measured.

### [Evaluation Criteria for Relative Permittivity]

| | |
|---|---|
| Good | Less than 3.0 |
| Acceptable | 3.0 or more and less than 3.5 |
| Poor | 3.5 or more |

### [Evaluation Criteria for Dielectric Loss Tangent]

| | |
|---|---|
| Good | Less than 0.003 |
| Acceptable | 0.003 or more and less than 0.005 |
| Poor | 0.005 or more |

The coefficient of linear thermal expansion (CTE) (CTE at 20° C. to 140° C.) of the adhesive layer obtained by curing at 150° C. or 200° C. for 60 minutes using the resin varnish of Example 1 was determined and then evaluated according to the following evaluation criteria.

[Coefficient of Linear Thermal Expansion (CTE) (ppm/K)]

The coefficient of linear thermal expansion (CTE) was measured via a tensile mode using a thermomechanical analyzer (product name: SII/SS7100 manufactured by Hitachi High-Tech Science Corporation) under the conditions of a load of 50 mN and a temperature increase rate of 5° C./min in the range of 10° C. to 200° C., and the coefficient of linear thermal expansion (ppm/K) was determined from the slope in the range of 20° C. to 140° C. The resin film was measured in the transverse direction (TD).

### [Evaluation Criteria for CTE (Ppm/K)]

| | |
|---|---|
| Good | CTE of less than 200 |
| Acceptable | CTE of 200 or more and less than 500 |
| Poor | CTE of 500 or more |

When the adhesive layer obtained by curing using the resin varnish of Example 1 was folded at 180°, it was confirmed whether or not a white mark remained (whitening occurred). The evaluation criteria for whitening are as follows.

### [Whitening]

| | |
|---|---|
| Good | No whitening occurs even when folded |
| Poor | Whitening occurs |

Using the resin varnish of Example 1, a laminate provided with an adhesive after curing was prepared by the following method.

<Laminate Having Adhesive after Curing>

The surface of the base film was subjected to a corona treatment.

The resin varnish prepared above was applied to the surface of the base film, and dried in an oven at 130° C. for 4 minutes. The solvent was volatilized to form an adhesive layer (25 μm), whereby a base film having an adhesive (a laminate provided with an adhesive) was obtained. The adhesive layer of the laminate provided with an adhesive was placed so as to be in contact with the glossy surface of an electrolytic copper foil, and pressed using a vacuum press machine at 180° C. under pressure (3 MPa) and 10 hPa for 3 minutes, and was then subjected to after-curing for 1 hour at 180° C. to cure the adhesive layer, whereby a laminate provided with an adhesive after curing was obtained.

The peeling force (adhesive force) (N/cm) between the electrolytic copper foil and the base film of the laminate provided with an adhesive after curing of Example 1 was measured.

### [Peeling Force (N/cm)]

The peeling force was measured by cutting the laminate provided with an adhesive after curing to obtain a test piece having a width of 25 mm, and then measuring the peeling strength when the electrolytic copper foil is peeled from the base film having an adhesive fixed to a support at a peeling angle of 180° C. at a peeling rate of 0.3 m/min in accordance with JIS Z0237: 2009 (pressure-sensitive adhesive tape/pressure-sensitive adhesive sheet test method), and was evaluated according to the following evaluation criteria.

### [Evaluation Criteria for Peeling Force]

| | |
|---|---|
| Excellent | 8 N/cm or more |
| Good | 7 N/cm or more and less than 8 N/cm |
| Acceptable | 6 N/cm or more and less than 7 N/cm |
| Poor | Less than 6 N/cm |

The laminate provided with an adhesive after curing of Example 1 was visually observed to confirm whether or not bubbles were generated in the adhesive layer. The evaluation criteria for bubbles are as follows.

### [Bubble]

| | |
|---|---|
| Good | No bubbles are generated |
| Poor | Bubbles are generated |

The results of each evaluation for the adhesive layer and laminate provided with an adhesive layer of Example 1 are shown in Table 2.

### Examples 2 to 6

The adhesive layers and laminates provided with an adhesive layer of Examples 2 to 6 were prepared in the same manner as in Example 1 except that the types and amounts to be blended of the components constituting the adhesive layer were changed in Example 1 as shown in Table 1.

The prepared adhesive layers and laminates provided with an adhesive layer were evaluated in the same manner as in Example 1.

The results are shown in Table 2.

### Comparative Examples 1 to 5

The adhesive layers and laminates provided with an adhesive layer of Comparative Examples 1 to 5 were prepared in the same manner as in Example 1 except that the types and amounts to be blended of the components constituting the adhesive layer were changed in Example 1 as shown in Table 1.

The prepared adhesive layers and laminates provided with an adhesive layer were evaluated in the same manner as in Example 1.

The results are shown in Table 2.

TABLE 1

| | Formulation (part by mass) | | | | | | |
|---|---|---|---|---|---|---|---|
| | Maleimide Resin | | | | | | |
| | (Bismaleimide Resin) | | | | | | |
| | SLK-3000- | SLK-6895- | | | | | |
| | T50 | M90 | | Benzoxazine Resin | | | |
| | (high molecular | (low molecular | Epoxy Resin | | BZ-LB- | | Silica |
| | weight) | weight) | HP-7200 | CR-276 | MDA | ALP-d | SO-C2 |
| Example 1 | 95 | | | 5 | | | 200 |
| Example 2 | 95 | | | | 5 | | 200 |
| Example 3 | 90 | | | 10 | | | 200 |
| Example 4 | 80 | | | 20 | | | 200 |
| Example 5 | 70 | | | 30 | | | 200 |
| Example 6 | 60 | | 30 | 10 | | | 200 |
| Comparative | | 95 | | | | 5 | 200 |
| Example 1 | | | | | | | |
| Comparative | 95 | | | | | 5 | 200 |
| Example 2 | | | | | | | |
| Comparative | | 95 | | 5 | | | 200 |
| Example 3 | | | | | | | |
| Comparative | | 70 | | 30 | | | 200 |
| Example 4 | | | | | | | |
| Comparative | 60 | | 30 | | | 10 | 200 |
| Example 5 | | | | | | | |

TABLE 2

| | Adhesive Layer (Cured Product) | | | | | | |
|---|---|---|---|---|---|---|---|
| | Relative | Dielectric loss | | | | Laminate | |
| | permittivity | tangent | CTE | CTE | | Peeling force | |
| | (28 GHz) | (28 GHz) | (150° C.) | (200° C.) | Whitening | (N/cm) | Bubble |
| Example 1 | Good | Good | Good | Good | Good | Excellent | Good |
| Example 2 | Good | Good | Good | Good | Good | Excellent | Good |
| Example 3 | Good | Good | Good | Good | Good | Excellent | Good |
| Example 4 | Good | Good | Good | Good | Good | Good | Good |
| Example 5 | Good | Acceptable | Good | Good | Good | Good | Good |
| Example 6 | Good | Acceptable | Good | Good | Poor | Acceptable | Good |
| Comparative | Good | Good | Poor | Good | Good | Poor | Good |
| Example 1 | | | | | | | |
| Comparative | Good | Good | Poor | Good | Good | Good | Poor |
| Example 2 | | | | | | | |
| Comparative | Good | Good | Acceptable | Good | Good | Poor | Good |
| Example 3 | | | | | | | |
| Comparative | Good | Acceptable | Good | Good | Good | Poor | Good |
| Example 4 | | | | | | | |
| Comparative | Good | Acceptable | Good | Good | Poor | Acceptable | Poor |
| Example 5 | | | | | | | |

As shown in Examples, the adhesive composition of the present invention exhibits good electrical properties (low dielectric properties) compatible with 5G and forms a good membrane (adhesive laver) by low temperature curing, and the formed adhesive layer exhibits excellent adhesiveness, bubble suppression, and a low CTE.

### INDUSTRIAL APPLICABILITY

The laminate having an adhesive layer composed of the adhesive composition of the present invention can be suitably used in the production of FPC-related products for electronic devices, including smartphones, mobile phones, optical modules, digital cameras, game machines, laptop computers and medical instruments.

1. An adhesive composition comprising a resin composition containing a maleimide resin having a molecular weight of 1,000 or more and a benzoxazine resin,
wherein the benzoxazine resin has a site represented by formula (1): 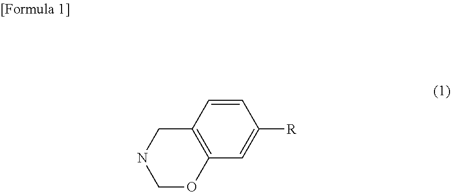
wherein R represents a hydrocarbon group having 4 or more carbon atoms, the hydrocarbon group optionally having an unsaturated binding site.

2. The adhesive composition according to claim 1, wherein R in formula (1) has 20 or less carbon atoms.

3. The adhesive composition according to claim 1, wherein R in formula (1) has a linear structure.

4. The adhesive composition according to claim 1, wherein the hydrocarbon group of R in formula (1) has at least one or more unsaturated binding sites.

5. The adhesive composition according to claim 1, wherein R in formula (1) comprises any one of groups represented by formulae (i) to (iv): 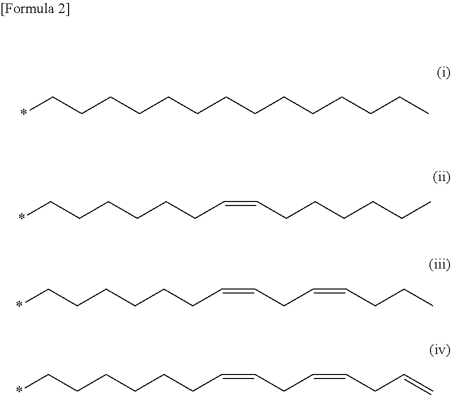 [SMILES: *CCCCCCCCCCCCCC ; *CCCCCC/C=C\CCCCCC ; *CCCCCC/C=C\C/C=C\CCC ; *CCCCCC/C=C\C/C=C\CC=C]
wherein * represents a bond.

6. The adhesive composition according to claim 1, wherein a content of the benzoxazine resin is more than 0 parts by mass and 20 parts by mass or less based on 100 parts by mass of the resin composition.

7. The adhesive composition according to claim 1, wherein the maleimide resin has a softening point of 30° C. or higher.

8. The adhesive composition according to claim 1, wherein the maleimide resin has a softening point of 130° C. or lower.

9. The adhesive composition according to claim 1, wherein when the resin composition further contains an epoxy resin, a content of the epoxy resin is 25 parts by mass or less based on 100 parts by mass of the resin composition.

10. The adhesive composition according to claim 1, wherein the resin composition is free of an epoxy resin.

11. The adhesive composition according to claim 1, further comprising a filler in addition to the resin composition.

12. An adhesive layer obtained by curing the adhesive composition according to claim 1.

13. The adhesive layer according to claim 12, wherein the adhesive layer has a relative permittivity of 3.5 or less and a dielectric loss tangent of 0.005 or less when measured at a frequency of 28 GHz.

14. A laminate comprising:
a base film; and
the adhesive layer according to claim 12.

15. A coverlay film provided with an adhesive layer, comprising the laminate according to claim 14.

16. A copper-clad laminate comprising the laminate according to claim 14.

17. A printed circuit board comprising the laminate according to claim 14.
